(19) United States
(12) Patent Application Publication
(10) Pub. No.: US 2025/0129200 A1
(43) Pub. Date: Apr. 24, 2025

(54) POLYISOCYANURATE FOAM-FORMING COMPOSITIONS, POLYISOCYANURATE FOAMS, INSULATED ASSEMBLIES, AND METHODS OF MAKING THEREOF

(71) Applicants: Covestro LLC, Pittsburgh, PA (US); Momentive Performance Materials Inc., Waterford, NY (US)

(72) Inventors: George Combs, Pittsburgh, PA (US); Xiaoqiang He, Parkersburg, WV (US)

(21) Appl. No.: 18/381,413

(22) Filed: Oct. 18, 2023

(51) Int. Cl. C08G 18/08; C08G 18/09; C08G 18/10; C08G 18/22; C08G 18/42; C08G 101/00; C08J 9/00; C08J 9/12; C08J 9/14

(52) U.S. Cl. CPC C08G 18/14; C08G 18/092; C08G 18/10; C08G 18/225; C08G 18/4208; C08J 9/0042; C08J 9/125; C08J 9/141; C08G 2101/00; C08G 2110/005; C08G 2115/02; C08G 2330/00; C08J 2203/10; C08J 2203/14; C08J 2205/052; C08J 2205/10; C08J 2375/06

(57) ABSTRACT

Polyisocyanurate foam-forming compositions, polyisocyanurate foams, insulated assemblies, and method of making thereof are provided. The polyisocyanurate foam-forming composition comprises an organic polyisocyanate and an isocyanate-reactive composition. The isocyanate-reactive composition comprises a polyether polyol or polyester polyol with a nominal hydroxyl functionality of at least 2.0, a blowing agent composition, a trimerization catalyst composition, and a surfactant. The blowing agent is present in an amount sufficient to produce a polyisocyanurate foam from the isocyanate-reactive composition that has a density of less than 1.8 lb/ft³ (28.8 kg/m³). The blowing agent composition comprises a hydrocarbon or hydrocarbon blend in an amount of at least 6% by weight and water in an amount less than 0.2% by weight. The trimerization catalyst composition comprises an alkali metal carboxylate or an alkaline metal carboxylate and a solvent that is not isocyanate-reactive.

### FIELD

The present disclosure is directed to, among other things, polyisocyanurate foam-forming compositions, polyisocyanurate foams, insulated assemblies, and methods of making thereof.

### BACKGROUND

Insulation plays an important role in the energy efficiency and environmental impact of building envelopes. In many cases, polyisocyanurate foam is used for building insulation, as it has many advantages, such as relatively low installed cost, good fire resistance, and high thermal resistance. As a result, it may be desirable to understand the thermal resistance performance of such foam insulation.

In order to allow for a simple, yet consistent, methodology to measure and compare thermal performance, North American manufacturers of building envelope thermal insulation test and report the R-value (a measure of thermal resistance used in the building and construction industry) of their products in compliance with industry standards. ASTM C518-17, Standard Test Method for Steady-State Thermal Transmission Properties by Means of the Heat Flow Meter Apparatus, is an industry method for measuring R-values of building insulation comprised of a cellular plastic insulation that contains gases other than air where the composition of the retained gases change with time. Two other methods referenced in that standard, ASTM C1058 (2010), Standard Practice for Selecting Temperatures for Evaluating and Reporting Thermal Properties of Thermal Insulation, Sections 4-5 and ASTM C1045 (2007), Standard Practice for Calculating Thermal Transmission Properties under Steady State Conditions, Section 6.2, address, respectively, the appropriate temperature ranges at which insulation thermal conductivity should be measured based on its intended use and the temperature settings for the apparatus hot and cold plates that should be chosen for accurate measurements.

A problem that has been associated with polyisocyanurate foam building insulation is that, unlike some other insulation materials, it has been reported that such insulation exhibits poorer thermal resistance, i.e., reduced R-value at low temperatures due to condensation of the gaseous blowing agents contained in the closed cells of the rigid foam.

Alkali or alkaline earth metal salts of carboxylic acids traditionally have been used to catalyze trimerization of excess isocyanate in rigid foam formulations to form isocyanurate groups that are extremely thermally stable and promote crosslinking of the foam polyurethane matrix. As has been pointed out in U.S. Pat. No. 8,729,146 and U.S. patent application No. 20070021581, these catalysts are solids that must be dissolved in solutions of short chain glycols, such as ethylene glycol or diethylene glycol, so that they can be used with current equipment to manufacture polyisocyanurate rigid foam insulation. The very high hydroxyl concentrations of glycol solvents consume considerable amounts of the isocyanante component, thus reducing the trimer yield of the formulation and increasing the amount of glycol-based urethane functional groups in the hard segment of the foam's polymer matrix. Glycol-free or nonreactive trimerization catalysts are now commercially available and are marketed as replacements for conventional glycol-based catalysts in polyisocyanurate foam formulations to either reduce isocyanate consumption or improve such properties as fire performance, dimensional stability, or compressive strength. Another benefit of reducing low molecular weight glycols in polyisocyanurate foam formulations is disclosed in U.S. Pat. Nos. 5,064,873 and 5,109,031, which claim that foams made with isocyanate-terminated quasi-prepolymers of polyester polyols or polyester polyols with free glycol content of less than 7% by weight exhibit lower k-factors (better R-values) and better R-value retention about one year after production. These patents disclose the use of phenolic tertiary amines in combination with alkali metal carboxylates in diethylene glycol solvent.

There are challenges with formulating polyisocyanurate foam-forming compositions that produce a faced rigid foam laminate having a measured R-value at a mean temperature of 40° F. (4.4° C.) or lower that is at least as high as the R-value of the same foam laminate at 75° F. (23.9° C.), when measured according to ASTM C518-17.

### SUMMARY

In one aspect according to the present disclosure, a polyisocyanurate foam-forming composition is provided. The polyisocyanurate foam-forming composition comprises an organic polyisocyanate and an isocyanate-reactive composition. The isocyanate-reactive composition comprises a polyether polyol or polyester polyol with a nominal hydroxyl functionality of at least 2.0, a blowing agent composition, a trimerization catalyst composition, and a surfactant. The blowing agent is present in an amount sufficient to produce a polyisocyanurate foam from the isocyanate-reactive composition that has a density of less than 1.8 lb/ft³ (28.8 kg/m³). The blowing agent composition comprises a hydrocarbon or hydrocarbon blend in an amount more than or equal to 6% by weight, based on the total weight of the polyisocyanurate foam-forming composition and water in an amount no more than 0.2% by weight, based on the total weight of the polyisocyanurate foam-forming composition. The trimerization catalyst composition comprises an alkali metal carboxylate or an alkaline metal carboxylate and a solvent that is not isocyanate-reactive.

The present disclosure also provides a polyisocyanurate foam-forming composition. The polyisocyanurate composition comprises an organic polyisocyanate and an isocyanate-reactive composition. The isocyanate-reactive composition comprises a polyether polyol or polyester polyol with a nominal hydroxyl functionality of at least 2.0, a blowing agent composition present in an amount sufficient to produce a polyisocyanurate foam that has a density of less than 1.8 lb/ft³ (28.8 kg/m³), 1.5% to 3.0% by weight, based on the total weight of the polyisocyanurate foam-forming composition, a trimerization catalyst composition, and a surfactant. The blowing agent composition comprises more than or equal to 6% by weight such as more than or equal to 6.4%, based on the total weight of the polyisocyanurate foam-forming composition, of hydrocarbon and water in an amount no more than 0.2% by weight, based on the total weight of the polyisocyanurate foam-forming composition. Where the hydrocarbon comprises cyclopentane and isopentane, the cyclopentane and isopentane are present in a weight ratio of 30:70 to 80:20; where the hydrocarbon comprises isopentane and n-pentane, the isopentane and n-pentane are present in a weight ratio of 70:30 to 20:80; or the hydrocarbon is n-pentane. The hydrocarbon and water are present in the blowing agent composition in a weight ratio of at least 50:1. The trimerization catalyst composition comprises an alkali metal carboxylate or an alkaline metal carboxylate and a solvent that is not isocyanate-reactive.

In another aspect according to the present disclosure, provided is a polyisocyanurate foam comprising the reaction product of a reaction mixture comprising an organic polyisocyanate and an isocyanate-reactive composition. The isocyanate-reactive composition comprises a polyether polyol or polyester polyol with a nominal hydroxyl functionality of at least 2.0, a blowing agent composition, a trimerization catalyst composition, and a surfactant. The blowing agent composition comprises more than or equal to 6% by weight, based on the total weight of the polyisocyanurate foam-forming composition, of a hydrocarbon and water in an amount no more than 0.2% by weight, based on the total weight of the polyisocyanurate foam-forming composition. The trimerization catalyst composition comprises an alkali metal carboxylate or an alkaline metal carboxylate and a solvent that is not isocyanate-reactive. The polyisocyanurate foam has a density of less than 1.8 lb/ft³ (28.8 kg/m³).

The present disclosure also provides a method of making a polyisocyanurate foam. The method comprises reacting an organic polyisocyanate and an isocyanate-reactive composition. The isocyanate-reactive composition comprises a polyether polyol or polyester polyol with a nominal hydroxyl functionality of at least 2.0, a blowing agent composition, a trimerization catalyst composition, and a surfactant. The blowing agent composition comprises more than or equal to 6% by weight, based on the total weight of the polyisocyanurate foam-forming composition, of a hydrocarbon and water in an amount no more than 0.2% by weight, based on the total weight of the polyisocyanurate foam-forming composition. The trimerization catalyst composition comprises an alkali metal carboxylate or an alkaline metal carboxylate and a solvent that is not isocyanate-reactive. The polyisocyanurate foam has a density of less than 1.8 lb/ft³ (28.8 kg/m³).

In yet another aspect according to the present disclosure, methods for producing a faced rigid foam laminate having a foam density of less than 1.8 lb/ft³ and an R-value measured at a temperature of 40° F. (4.4° C.) that is at least as high as the R-value of the same foam laminate measured at 75° F. (23.9° C.), each when measured according to ASTM C518-17, are provided. The method comprises reacting an organic polyisocyanate and an isocyanate-reactive composition. The isocyanate-reactive composition comprises a polyether polyol or polyester polyol with a nominal hydroxyl functionality of at least 2.0, a blowing agent composition, a trimerization catalyst composition, and a surfactant. The blowing agent composition comprises more than or equal to 6% by weight, based on the total weight of the polyisocyanurate foam-forming composition, of a hydrocarbon and water in an amount no more than 0.2% by weight, based on the total weight of the polyisocyanurate foam-forming composition. The trimerization catalyst composition comprises an alkali metal carboxylate or an alkaline metal carboxylate and a solvent that is not isocyanate-reactive.

It is understood that the invention described in this specification is not necessarily limited to the examples summarized in this Summary.

### DETAILED DESCRIPTION

Various embodiments are described and illustrated in this specification to provide an overall understanding of the structure, function, properties, and use of the disclosed inventions. It is understood that the various embodiments described and illustrated in this specification are non-limiting and non-exhaustive. Thus, the invention is not limited by the description of the various non-limiting and non-exhaustive embodiments disclosed in this specification. The features and characteristics described in connection with various embodiments may be combined with the features and characteristics of other embodiments. Such modifications and variations are intended to be included within the scope of this specification. As such, the claims may be amended to recite any features or characteristics expressly or inherently described in, or otherwise expressly or inherently supported by, this specification. Furthermore, Applicant(s) reserves the right to amend the claims to affirmatively disclaim features or characteristics that may be present in the prior art. The various embodiments disclosed and described in this specification can comprise, consist of, or consist essentially of the features and characteristics as variously described herein.

Unless otherwise indicated by the context, as used herein, the term “mean insulation temperature” when used with reference to measurement of an R-value or thermal conductivity (k-factor) of an insulation material means the mathematical mean of the two parallel plate temperatures in contact with either surface of the insulation material being tested.

As used herein, “Relative Hydrocarbon Solubility” refers to the relative change in solubility of hydrocarbon to be used in the blowing agent composition being considered for use in the polyisocyanurate foam-forming composition in the polyol composition being considered for use in the polyisocyanurate foam-forming composition, upon inclusion of a surfactant being considered or upon increase in the amount of a surfactant being considered. Relative Hydrocarbon Solubility can be determined by adding the blowing agent composition to such polyol composition, optionally also in the presence of some surfactant, on the one hand, and separately adding the blowing agent composition to a blend of the polyol composition and a surfactant, on the other hand, in each case in the level of blowing agent composition required to achieve the desired foam density, to form an emulsion. After allowing the emulsion to separate, the amount of blowing agent composition dissolved in the saturated polyol phase is measured, such as by using direct insertion GC analysis. The Relative Hydrocarbon Solubility is the amount of the blowing agent composition dissolved in the polyol composition/surfactant blend divided by the amount of blowing agent composition dissolved in the polyol composition that is either free of surfactant or containing less surfactant than the other blend.

As used herein, “Surfactant Water Solubility” refers to the minimum amount of non-reactive surfactant added to water (such as deionized water) at room temperature (70° F. to 75° F.) that causes the onset of persistent visually observable (to the naked human eye) turbidity or cloudiness after thorough mixing of the combination. If a concentration of at least 5% by weight of the surfactant in water does not cause such turbidity or cloudiness, then it is considered to be “water soluble” for the purpose of this specification. As used herein, “Surfactant Turbidity” refers to the turbidity of the water/surfactant mixture containing persistent visually observable (to the naked human eye) turbidity or cloudiness after thorough mixing of the combination, measured with a turbidimeter, as described in the Examples.

The present inventors have determined it would be desirable to provide polyisocyanurate foam-forming compositions that produce a faced rigid foam laminate having a measured R-value at a mean temperature of 40° F. (4.4° C.) or lower that is at least as high as the R-value of the same foam laminate at 75° F. (23.9° C.), when measured according to ASTM C518-17. Surprisingly, the present inventors have found that certain trimerization catalysts when used in combination with polyisocyanurate foam-forming compositions of the present disclosure improve low-temperature R-value performance of rigid foam insulation prepared from catalyst compositions free of low molecular weight glycols.

The polyisocyanurate foam-forming compositions according to the present disclosure may comprise: (a) an organic polyisocyanate, and (b) an isocyanate-reactive composition. For example, a polyisocyanurate foam can be formed from a reaction product of a reaction mixture comprising (a) an organic polyisocyanate, and (b) an isocyanate-reactive composition. The isocyanate-reactive composition may comprise (1) a polyol composition comprising a polyether polyol or a polyester polyol with a nominal hydroxyl functionality of at least 2.0, (2) a blowing agent composition, (3) a trimerization catalyst composition (e.g., a trimerization catalyst dissolved in a non-reactive solvent), and (4) a surfactant (e.g., a non-reactive silicone surface-active agent). Insulated assemblies, such as, for example, insulated roof assemblies, can comprise the polyisocyanurate foams.

The organic polyisocyanate can comprise any of the known organic polyisocyanates. Examples of suitable polyisocyanates include, without limitation, substituted or unsubstituted aromatic, aliphatic, and cycloaliphatic polyisocyanates having at least two isocyanate groups. For example, polyfunctional aromatic isocyanates can be used. Specific examples of suitable aromatic isocyanates include, but are not limited to, 4,4′-diphenylmethane diisocyanate (MDI), polymeric MDI (pMDI), toluene diisocyanate, allophanate-modified isocyanates, isocyanate-terminated prepolymers, and carbodiimide-modified isocyanates. The organic polyisocyanate may comprise pMDI having an average isocyanate (NCO) functionality of from 2.2 to 3.3 and a viscosity of from 25 to 2000 mPas and prepolymers thereof prepared with polyols or other oligomers or polymers, such as polyether or polyester polyols that contain active hydrogen atoms. The pMDI may have a functionality of from 2.2 to 3.0 and a viscosity less than about 800 mPas at 25° C. Any mixtures of organic polyisocyanates may, of course, be used.

The organic polyisocyanate(s) may be included in the foam-forming system, i.e., composition, in an amount of at least 50%, such as from 55% to 75%, or, in some cases, from 59% to 69% by weight, based on total weight of the polyisocyanurate foam-forming composition.

The polyol composition may comprise a polyether polyol or a polyester polyol with a nominal hydroxyl functionality of at least 2.0. The polyol composition may have, for example, an average hydroxyl functionality in a range of 2 to 8, such as 2 to 6 or 2.0 to 2.5, and/or a hydroxyl number in a range of 100 mg KOH/gm polyol to 1000 mgKOH/gm polyol or 200 mgKOH/gm polyol to 500 mgKOH/gm polyol. The polyol composition can comprise a blend of an aromatic polyester polyol and a polyester and/or polyether polyol that contains renewable content derived from incorporation of regenerable materials, such as fatty acid triglycerides, sugar, or natural glycerin. The polyol composition may be present in an amount of 10% to 40%, such as 20% to 40%, or, in some cases, 25% to 35% by weight, based on total weight of the polyisocyanurate foam-forming composition.

The polyol composition may comprise an aromatic polyester polyol, optionally in combination with a polyether polyol. The relative amounts of organic polyisocyanate and the polyol composition used in the polyisocyanurate foam-forming composition can be selected to provide the polyisocyanurate foam-forming composition with a NCO: OH index of at least 1.8, such as at least 2.0, or in a range of 2.0 to 3.0.

The blowing agent composition may comprise a hydrocarbon and water. As used herein, “hydrocarbon” refers to chemical compounds composed primarily of carbon and hydrogen that may contain heteroatoms such as oxygen, nitrogen, sulfur, or other elements. Halogenated blowing agents with a global warming potential (GWP)≥25 (100 year) and ozone depletion potential (ODP)>0 may not be employed in the practice of polyisocyanurate foam-forming compositions of the present disclosure.

The hydrocarbon in the blowing agent can comprise an atmospheric pressure boiling point of at least 20° C. (68° F.). Specific examples of suitable hydrocarbons with an atmospheric pressure boiling point of at least 20° C. (68° F.) include, but are not limited to, n-pentane (atmospheric pressure boiling point of 36.1° C. (96.9° F.)), isopentane (atmospheric pressure boiling point of 27.7° C. (81.9° F.)), cyclopentane (atmospheric pressure boiling point of 49° C. (120.2° F.)), hexane (atmospheric pressure boiling point of 68° C. (154.4° F.)), 2,2-dimethylbutane (atmospheric pressure boiling point of 50° C. (122° F.)), 2-methylpentane (atmospheric pressure boiling point of 60° C. (140° F.)), 1-hexene (atmospheric pressure boiling point of 63° C. (145.4° F.)), 1-pentene (atmospheric pressure boiling point of 30° C. (86° F.)), acetone (atmospheric pressure boiling point of 56° C. (132.8° F.)), acetaldehyde (atmospheric pressure boiling point of 20.2° C. (68.4° F.)), dimethyl carbonate (atmospheric pressure boiling point of 90° C. (194° F.)), methylal (atmospheric pressure boiling point of 42.3° C. (108.1° F.)), ethyl formate (atmospheric pressure boiling point of 54.3° C. (129.7° F.)), methyl acetate (atmospheric pressure boiling point of 56.9° C. (134.4° F.)), and methyl formate (atmospheric pressure boiling point of 31.8° C. (89.2° F.)). As will be appreciated, mixtures of two or more of any of the foregoing or unlisted suitable hydrocarbons can be used. For example, the hydrocarbon with an atmospheric pressure boiling point of at least 20° C. (68° F.) can comprise n-pentane, isopentane, cyclopentane, or a mixture of two or more thereof. The hydrocarbons with an atmospheric pressure boiling point of at least 20° C. (68° F.) can comprise n-pentane, isopentane, and/or cyclopentane.

The hydrocarbon with an atmospheric pressure boiling point of at least 20° C. (68° F.) may be present in an amount such that an “effective hydrocarbon blowing agent vapor pressure” is equivalent to its saturation vapor pressure at 60° F. (15.6° C.) or lower temperature where onset of hydrocarbon condensation may occur. As described in this specification, the “effective hydrocarbon blowing agent vapor pressure” takes into account the weight fraction of the blowing agent that may be dissolved in the polymer matrix. Use of the trimerization catalysts of the present disclosure shifts the blowing agent condensation to temperatures lower than 60° F. (15.6° C.) as compared to condensation temperatures equal to or higher than 60° F. (15.6° C.) when conventional trimerization catalysts dissolved in glycols are used. The hydrocarbon in the blowing agent may be present in an amount of more than or equal to 6% by weight, such as more than or equal 6.4% by weight, more than or equal to 6.95% by weight, more than or equal to 7% by weight, or up to 10% by weight, based on total weight of the polyisocyanurate foam-forming composition. The amount of hydrocarbon included in the polyisocyanurate foam-forming composition can be in a range of 6% to 10% by weight, such as 6.95% to 9% by weight or 7% to 9% by weight, all based on total weight of the polyisocyanurate foam-forming composition.

If desired, it is also possible that the blowing agent composition comprises a hydrocarbon, such as a hydrofluoroolefin, having an atmospheric pressure boiling point of less than 20° C. (68° F.). Specific examples of these include, but are not limited to, butane (atmospheric pressure boiling point of −1° C. (30.2° F.)), isobutane (atmospheric pressure boiling point of −11.7° C. (10.9° F.)), butylene (atmospheric pressure boiling point of −6.6° C. (20.1° F.)), isobutylene (atmospheric pressure boiling point of −6.9° C. (19.6° F.)), trans-1-chloro-3,3,3-trifluoropropene (atmospheric pressure boiling point of 19° C. (66.2° F.)), and dimethyl ether (atmospheric pressure boiling point of −24° C. (−11.2° F.)).

The hydrocarbon in the blowing agent composition may exhibit solubility in the polyol composition of the polyisocyanurate foam-forming composition that is less than 15% by weight but greater than 5% in the absence of any other additives or surface-active agent surfactants. The selection of the surfactant may increase the solubility of the hydrocarbon in the blowing agent composition in the polyol composition of the polyisocyanurate foam-forming composition by at least 5% or at least 14%, relative to its baseline solubility. Surprisingly, higher boiling point hydrocarbons in the blowing agent that exhibit baseline solubility in the polyol composition of the polyisocyanurate foam-forming composition greater than 15% or even greater than 20% (e.g., cyclopentane, toluene) can be used to produce low-density foams from comparative foam-forming compositions described in this specification that exhibit a crossover temperature of 25° F. (−3.9° C.) to 35° F. (1.7° C.) when comprising hydrocarbons used at concentrations greater than 6% by weight, based on the total weight of the polyisocyanurate foam-forming composition.

In addition to the hydrocarbon, water may be included in the blowing agent composition. The water can take various forms, such as, for example, deionized, distilled, tap, or other suitable form. Water can react with isocyanates to produce carbon dioxide gas as an auxiliary blowing agent. The amount of water included in the foam-forming composition will often range from 0.01% to 0.50% by weight, such as 0.1% to 0.40% by weight, 0.1% to 0.35% by weight, or 0.15% to 0.25% by weight, all based on total weight of the foam-forming composition. It may be advantageous to limit the amount of water and increase the relative amount of hydrocarbon in the blowing agent composition to improve thermal conductivity of polyisocyanurate foams made with the polyisocyanurate foam-forming composition of the present disclosure. For example, the blowing agent composition may comprise no more than 0.2% by weight of water, based on the total weight of the polyisocyanurate foam-forming composition, such as, for example, no more than 0.15% by weight of water or no more than 0.10% by weight of water, all based on the total weight of the polyisocyanurate foam-forming composition. The hydrocarbon and water can be present in the blowing agent composition in a weight ratio of at least 50:1, such as, for example, at least 70:1.

The blowing agent composition may be present in an amount sufficient to produce a polyisocyanurate foam having a density of less than 1.8 lb/ft³, such as, for example, in a range of 1.28 to 1.80 lb/ft³ (20.5 to 28.8 kg/m³) while using no more than 0.2% by weight of water, based on the total weight of the polyisocyanurate foam-forming composition. The blowing agent composition can be present in an amount sufficient to produce a polyisocyanurate foam that exhibits an R-value measured according to ASTM C518-17 at a mean temperature of 40° F. that is at least as high as the R-value exhibited by the foam when measured at a mean temperature of 75° F.

The trimerization catalyst composition can comprise a trimerization catalyst and a solvent that is not isocyanate reactive (e.g., a non-reactive solvent). The trimerization catalyst can comprise an alkali metal carboxylate, an alkaline metal carboxylate, or certain tertiary amines. The trimerization catalyst may be dissolved in solvents that that are not isocyanate reactive, such as those disclosed in U.S. Pat. No. 8,729,146 and U.S. patent application No. 20070021581, which are both incorporated fully herein by reference. The alkali metal carboxylate or alkaline metal carboxylate can comprise potassium. The alkali metal carboxylate or alkaline metal carboxylate can comprise an octoate. For example, the trimerization catalyst can comprise potassium octoate, such as, for example, NIAX™ Catalyst K-Zero G, available from Momentive Performance Materials Inc., Wilton, Connecticut.

Trimerization catalysts may be used in an amount that can measurably increase the rate of reaction of the polyisocyanate. For example, the trimerization catalyst can be present in an amount in a range of 0.1% to 10.0% by weight, such as 1.5% to 3% based on the total weight of the polyisocyanurate foam-forming composition. One or more additional catalysts may be used in the foam-forming composition. Suitable catalysts include, for example, tertiary amines, such as, without limitation, triethylenediamine, N-methylmorpholine, pentamethyldiethylenetriamine, dimethylcyclohexylamine, tetramethylethylenediamine, 1-methyl-4-dimethylaminoethyl-piperazine, 3-methoxy-N-dimethyl-propylamine, N-ethylmorpholine, diethylethanol-amine, N-cocomorpholine, N,N-dimethyl-N′,N′-dimethylisopropyl-propylene diamine, N,N-diethyl-3-diethyl aminopropylamine, bis(2-dimethylaminoethyl) ether, and dimethyl-benzyl amine.

As used herein, “non-reactive” means that the molecular structure of the solvent does not contribute any isocyanate-reactive functional groups to the foam-forming composition, such as reactive —OH, —SH, or —NH groups. In various examples, the solvent in the trimerization catalyst composition does not comprise glycol or other alcohol. The solvent in the trimerization catalyst composition may comprise an aprotic solvent, such as, for example, a methoxyether, polyethylene glycol di-2-ethylhexanoate, an acetate, an adipate, a phthalate, a ketone, a phosphate ester, a tertiary amine, a dialkyl sulfoxide, a N,N-dialkylalkanoamide, an aryl or alkyl phosphonate, a trialkyl phosphate, an organic carbonate, or a mixture of two or more thereof. For example, the solvent in the trimerization catalyst composition may comprise di-ethyl-ethyl-phosphonate, tetramethylenesulfone, 1-methyl-2-pyrrolidinone, triethylphosphate, tributylethylphosphate, acetonitrile, dimethylcarbonate, dimethylbenzylamine, dimethylaminopropylhexahydrotriazine, pentamethyldiethylenamine, di-isobutylchetone, methyl n-amyl ketone, or any combination thereof.

These non-reactive solvents can replace polyol type solvents having a high degree of OH groups generally used in the production of polyurethane or polyisocyanurates. The non-reactive solvents used in a solution, in accordance with the present disclosure, may also provide a solution having a low viscosity suitable for production of polyurethane and/or polyisocyanurates.

The solvent in the trimerization catalyst may be an ether having no free hydroxyl groups. The solvent may be: an ester having no free hydroxyl groups derived from a mono, di-, or poly-carboxylic acid with a monol, diol, triol, or glycol ether; a triglyceride derived from an aliphatic or aromatic acid with glycerol; an amide having no free-NH groups derived from an aliphatic or aromatic carboxylic acid with an amine; or any combination thereof. The solvent may also be a silane or siloxane polyalkyleneoxide copolymer having no free hydroxyl groups.

The trimerization catalyst composition can be present in an amount of 1.5% to 3.0% by weight, based on the total weight of the polyisocyanurate foam-forming composition. The trimerization catalyst composition can comprise water in an amount of less than 25% by weight, based on the total weight of the trimerization catalyst composition, such as, for example, in an amount of less than 5% by weight, based on the total weight of the trimerization catalyst composition.

The polyisocyanurate foam-forming composition may comprise a surfactant (e.g., a surface active agent), that may be used, for example, to stabilize the foaming reaction mixture until it obtains rigidity. The surfactant that may be utilized can be a non-reactive silicone surface-active agent. As used herein, “non-reactive” means that the molecular structure of the surfactant does not contribute a significant amount of isocyanate-reactive functional groups to the foam-forming composition, such as reactive —OH, —SH, or —NH groups, i.e., a hydroxyl number of not less than 20 mg KOH/g of surfactant or no less than 10 mg KOH/g of surfactant and no more than about 300 mg KOH/g of surfactant. As used herein, “silicone” is synonymous with polysiloxane polymers, which are based on a structure comprising alternate silicon and oxygen atoms. The silicone may be a silicone polyether that contains, in addition to alternating silicon and oxygen atoms, polyether linkages that can be pendant to the molecular backbone where a majority of the terminal functional groups of the pendant polyethers are reactive. The surfactant can be present in an amount in a range of 0.1% to 10% by weight, such as 0.5% to 1% by weight based on the total weight of the polyisocyanurate foam-forming composition.

To formulate polyisocyanurate foam-forming compositions of the present disclosure, a Relative Hydrocarbon Solubility and, optionally, a Surfactant Water Solubility and/or a Surfactant Turbidity can be measured or evaluated. For example, both the Surfactant Water Solubility and the Surfactant Turbidity can be evaluated and the polyisocyanurate foam-forming composition can be subsequently formulated in light of the results of that evaluation. Such an evaluation can be implemented in any of a variety of ways, including, but not limited to, software implementation, if desired.

The polyisocyanurate foam-forming composition can comprise a surfactant having (i) the Relative Hydrocarbon Solubility of at least 1.20; (ii) the Surfactant Water Solubility of less than 2%, the Surfactant Turbidity greater than 100, optionally greater than 150, and the Relative Hydrocarbon Solubility of at least 1.05 and less than 1.20; or (iii) the Surfactant Turbidity less than 100, and the Relative Hydrocarbon Solubility of at least 1.05 and less than 1.20.

It has been surprisingly discovered that improved low-temperature thermal insulation performance of the low-density polyisocyanurate foams produced from the foam-forming compositions described in this specification can be achieved by utilizing a surfactant in the amounts described above in combination with glycol-free trimerization catalyst compositions of the present disclosure rather than a conventional trimerization catalyst in a glycol solvent, if the surfactant exhibits at least one of the properties described in this specification. These low-density polyisocyanurate foams can exhibit a crossover temperature of no more than 40° F. or less than 35° F. when utilizing a surfactant, in the amounts described above in combination with glycol-free trimerization catalyst compositions of the present disclosure with a blowing agent composition comprising more than or equal to 6% based on the total weight of the polyisocyanurate foam-forming composition of hydrocarbon, if the surfactant exhibits this combination of Relative Hydrocarbon Solubility, Surfactant Water Solubility, and Surfactant Turbidity.

The surfactant can be a non-reactive silicone surface-active agent surfactant and may exhibit either Relative Hydrocarbon Solubility of at least 1.20 with a Surfactant Water Solubility of greater than 2.0% and a Surfactant Turbidity of less than 100, or exhibit Surfactant Water Solubility of less than 2%, Surfactant Turbidity greater than 100, and Relative Hydrocarbon Solubility of at least 1.05 and less than 1.20. It has also been surprisingly discovered that, in at least some cases, good low-temperature thermal insulation performance of the low-density foams produced from the polyisocyanurate foam-forming compositions described in the present disclosure can be achieved by utilizing a non-reactive silicone surface-active agents surfactant, in the amounts described above, exhibiting such particular combination of attributes. It has been unexpectedly discovered that low-density foams produced from the foam-forming compositions described in this specification can exhibit a crossover temperature of 25° F. (−3.9° C.) to 35° F. (1.7° C.) using a hydrocarbon blowing agent mixture comprised of more than 50% by weight of cyclopentane and less than 50% by weight of isopentane where the hydrocarbon mixture comprises more than or equal to 6.4% by weight, such as 6.95% by weight of the total foam-forming composition when utilizing non-reactive silicone surface-active agent, in the amounts described above, if the non-reactive silicone surface-active agent surfactant exhibits either Relative Hydrocarbon Solubility of at least 1.20, or the combination of Surfactant Water Solubility of less than 2%, Surfactant Turbidity greater than 100, and Relative Hydrocarbon Solubility of at least 1.05 and less than 1.20 or the combination of Surfactant Turbidity less than 100 and Relative Hydrocarbon Solubility at least 1.05 and less than 1.20.

The polyisocyanurate foam-forming composition can also comprise various other components, such as, for example, a flame retardant. Suitable flame retardants for use in the polyisocyanurate foam-forming composition comprise, without limitation, halogenated flame retardants, such as brominated flame retardants, such as brominated polyols, and phosphonated flame retardants, such as a halogenated phosphonates, such as chlorinated phosphates.

The brominated flame retardant may comprise a brominated polyether polyol of the general formula (I):

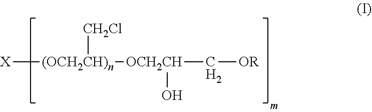

in which n is a number of 0 to 7, m is a number of 2 to 3; X is a saturated or unsaturated brominated polyol residue; and R is hydrogen or an alkyl group having 1 to 5 carbon atoms. Specific examples of suitable brominated polyether polyols are commercially available as Ixol® B-251 and Ixol® M-125 from Solvay Fluorides LLC, which are believed to be produced using the procedure described in U.S. Pat. Nos. 4,020,024, 4,067,911 and 4,072,638. Other suitable brominated flame retardants include, but are not limited to, 3,4,5,6-tetrabromophthalic acid, tribromoneopentyl alcohol, 1,3-propanediol, 2,2-bis(bromomethyl), and pentabromophenyl ether, among others, including mixtures of two or more thereof. Suitable commercially available brominated flame retardants also include those available from ICL Industrial Products, such as the SaFRon® (6000 Series) brominated flame retardants. Mixtures of two or more of such brominated flame retardants can be used. In certain examples, the brominated flame retardant does not contain phosphorous.

Specific examples of suitable phosphorous compounds, such as halogenated phosphates, include, without limitation, tris-(2-chloroethyl)phosphate, tris-(2-chloroisopropyl)phosphate (TCPP), tris(1,3-dichloroisopropyl)phosphate, tris-(2,3-dibromopropyl)phosphate and tetrakis-(2-chloroethyl) ethylene diphosphate, diethyl Bis-(2-hydroxyethyl)aminomethylphosphonate, phosphoric acid, triethyl ester, polymer with oxirane and phosphorus oxide (P₂O₅), and triethyl phosphate, including mixtures of two or more thereof. Isocyanate-reactive and/or non-reactive non-halogenated phosphorous compounds are often used, such as diethyl (hydroxymethyl)phosphonate.

The total amount of flame retardant in the polyisocyanurate foam-forming composition may be at least 1% by weight, such as at least 2% by weight and no more than 10% by weight, such as no more than 5% by weight, based on the total weight of the foam-forming composition.

The polyisocyanurate foam-forming compositions described herein can be used in the production of faced rigid foam laminates by reacting the organic polyisocyanate and the isocyanate-reactive composition. Any of the known techniques for producing a rigid polyisocyanurate faced foam laminate may be used. As used herein, the term “polyisocyanurate faced rigid foam laminate” refers to a structure comprising a polyisocyanurate foam core having two major surfaces and a facing material adhered to at least one of the major surfaces of the foam. As indicated, in the present disclosure, the foam in such polyisocyanurate faced foam laminate may be a rigid foam that for purposes of the present disclosure refers to a foam that meets the compressive strength and flexural strength values listed in Table 1 of ASTM C1289-15.

Various processes for producing polyisocyanurate faced foam laminates can be used. Examples of suitable processes include: methods for producing polyisocyanurate laminated boardstock insulation; froth-forming method for continuously producing glass fiber reinforced insulation boards in accordance with teachings of U.S. Pat. No. 4,572,865; continuous or discontinuous methods for producing insulated metal panels; and methods for producing molded or free-rise rigid foam articles. Another suitable method is disclosed in U.S. Pat. No. 8,106,106.

In the polyisocyanurate faced foam laminate, the facing material adhered to at least one of the major surfaces of the foam often comprises a layer or layers of organic and/or inorganic fibers or flexible foils, such as aluminum foils. Suitable natural organic fibers include, but are not limited to, cotton and cotton waste fibers; regenerated cellulose staple fibers and cellulose acetate fibers. Suitable synthetic organic fibers include, but are not limited to, polyester fibers, polyamide fibers, polyvinyl acetal fibers, and polypropylene fibers. Suitable inorganic fibers include, but are not limited to, glass fibers, glass wool fibers, mineral wool fibers, rock wool fibers, and slag wool fibers. Combinations of the above fibers also can be used. The fibrous layer(s) is often such that a polymeric foam that is frothed in place on the layer(s) can be readily introduced among the fibers thereof without penetrating or wetting entirely through the layer(s). A fiberglass facer mat comprising chopped glass fibers oriented in a random pattern and bonded together with a suitable binder may be used.

The polyisocyanurate faced foam laminate may be produced by a method comprising: (a) conveying a lower fibrous facing layer along a production line: (b) mixing an organic polyisocyanate and an isocyanate-reactive composition in the presence of the blowing agent composition in the isocyanate-reactive composition to form a foaming mixture; (c) depositing the foaming mixture onto the lower fibrous facing layer as it is conveyed along the production line; and (d) allowing the foaming mixture to expand and contact an advancing upper fibrous facing layer as it is conveyed along the production line. Such methods are described, for example, in U.S. Pat. No. 4,572,865 at col. 4, line 58 to col. 9, line 47.

The resulting faced foam laminate may have a core foam density of less than 1.8 lb/ft³ (29.6 kg/m³), such as in a range of 1.28 to less than 1.80 lb/ft³ (20.5 to 28.8 kg/m³). Moreover, the thickness of the fully expanded foam core may be from 0.25 to 6 inches (6.35 to 152.4 millimeters), such as 1 to 4 inches (25.4 to 101.6 millimeters), or, in some cases, 1.5 to 3 inches (38.1 to 76.2 millimeters).

The present disclosure provides methods for producing a faced rigid foam laminate having a foam density of less than 1.8 lb/ft³ and an R-value measured at a temperature of 35° F. (1.7° C.), 25° F. (−3.9° C.) or, in some cases, 20° F. (−6.7° C.), that is at least as high as the R-value of the same foam laminate measured at 75° F. (23.9° C.), each when measured according to ASTM C518-17. The methods may comprise reacting (a) an organic polyisocyanate, and (b) an isocyanate-reactive composition. The isocyanate-reactive composition may comprise: (1) a polyester polyol with a nominal hydroxyl functionality of at least 2.0 in the presence of 2) a blowing agent composition present in an amount sufficient to produce foam having a density of less than 1.8 lb/ft³ and comprising: (i) a hydrocarbon having an atmospheric pressure boiling point of at least 68° F. (20° C.), and (ii) no more than 0.2% by weight of water based on the total weight of the foam-forming composition, 3) a trimerization catalyst dissolved in a solvent that is not isocyanate reactive, and (4) a non-reactive silicone surface-active agent that has a Relative Hydrocarbon Solubility of at least 1.20, such as at least 1.25, or a Surfactant Water Solubility of 1.0% to 2.0%, such as 1.0% to 1.5%, and a Surfactant Turbidity of at least 150, such as 150 to 400 or Surfactant Turbidity less than 100, and Relative Hydrocarbon Solubility of at least 1.05 and less than 1.20 and optionally (5) a flame retardant. Suitable examples of each component and their respective amounts are set forth hereinabove.

The polyisocyanurate foam-forming compositions can produce a faced rigid foam laminate having a measured R-value at a temperature of 40° F. (4.4° C.), such as, for example, at a temperature of 35° F. (1.7° C.), at a temperature of 30° F. (−1.1° C.), at a temperature of 25° F. (−3.9° C.), or at a temperature of 20° F. (−6.7° C.), that is at least as high as the R-value of the same foam laminate at 75° F. (23.9° C.), each when measured according to ASTM C518-17. For simplification, the term “crossover temperature” may be used in this specification to refer to the temperature where the R-value of a faced rigid foam laminate is equal to its R-value at 75° F. (23.9° C.). Also, the term “relative R-value Index” (RRI) at a given temperature may be used in this specification to represent the R-value of a faced rigid foam laminate at that temperature minus its R-value at 75° F. (23.9° C.) divided by its R-value at 75° F. (23.9° C.) expressed in percent. Without being bound by any particular theory, it is believed that reduction in the amount of “chain extender”-type glycols in the polyisocyanurate foam formulations is accompanied by a reduction in the weight fraction of very polar polyurethane hard segments in the polymer matrix, thus enhancing the potential for solubilization or dissolution of less polar hydrocarbons in the matrix.

An insulated assembly, such as, for example, an insulated roof assembly, is also provided. The insulated roof assembly comprises (a) a deck, and (b) insulation panels attached to the deck, the insulation panels comprising the polyisocyanurate foam according to the present disclosure.

Various aspects of the subject matter described herein are set out in the following numbered clauses:

Clause 1: A polyisocyanurate foam-forming composition comprising: (a) an organic polyisocyanate; and (b) an isocyanate-reactive composition comprising: (1) a polyether polyol or polyester polyol with a nominal hydroxyl functionality of at least 2.0; (2) a blowing agent composition present in an amount sufficient to produce a polyisocyanurate foam that has a density of less than 1.8 lb/ft³ (28.8 kg/m³) and comprising: (i) more than or equal to 6% by weight, such as more than or equal to 6.4% by weight, based on the total weight of the polyisocyanurate foam-forming composition, of a hydrocarbon; and (ii) water in an amount no more than 0.2% by weight, based on the total weight of the polyisocyanurate foam-forming composition; (3) a trimerization catalyst composition comprising: (i) an alkali metal carboxylate or an alkaline metal carboxylate, and (ii) a solvent that is not isocyanate-reactive; and (4) a surfactant.

Clause 2: The polyisocyanurate foam-forming composition of Clause 1, wherein the trimerization catalyst composition comprises water in an amount of less than 25% by weight, based on the total weight of the trimerization catalyst composition, such as, less than 5% by weight, based on the total weight of the trimerization catalyst composition.

Clause 3: The polyisocyanurate foam-forming composition of any one of Clauses 1-2, wherein the alkali metal carboxylate or alkaline metal carboxylate comprises potassium.

Clause 4: The polyisocyanurate foam-forming composition of any one of Clauses 1-3, wherein the alkali metal carboxylate or alkaline metal carboxylate comprises an octoate.

Clause 5: The polyisocyanurate foam-forming composition of any one of Clauses 1-4, wherein the solvent comprises an aprotic solvent, such as a methoxyether, polyethylene glycol di-2-ethylhexanoate, an acetate, an adipate, a phthalate, a ketone, a phosphate ester, a tertiary amine, a dialkyl sulfoxide, a N,N-dialkylalkanoamide, an aryl or alkyl phosphonate, a trialkyl phosphate, an organic carbonate, or a mixture of two or more thereof.

Clause 6: The polyisocyanurate foam-forming composition of any of Clauses 1-5, wherein the hydrocarbon comprises n-pentane, isopentane, cyclopentane, or a mixture of two or more thereof.

Clause 7: The polyisocyanurate foam-forming composition of any one of Clauses 1-6, wherein the hydrocarbon consists of n-pentane.

Clause 8: The polyisocyanurate foam-forming composition of any of Clauses 1-6, wherein the hydrocarbon comprises cyclopentane and isopentane, wherein the cyclopentane and isopentane are present in a weight ratio of 30:70 to 80:20, such as 70:30.

Clause 9: The polyisocyanurate foam-forming composition of any of Clauses 1-6, wherein the hydrocarbon comprises isopentane and n-pentane, wherein the isopentane and n-pentane are present in a weight ratio of 70:30 to 20:80.

Clause 10: The polyisocyanurate foam-forming composition of any of Clauses 1-9, wherein hydrocarbon and water are present in the blowing agent composition in a weight ratio of at least 50:1, such as at least 70:1.

Clause 11: The polyisocyanurate foam-forming composition of any of Clauses 1-10, wherein the water is present in the blowing agent composition in an amount of no more than 0.15% by weight, based on the total weight of the polyisocyanurate foam-forming composition, such as no more than 0.10% by weight, based on the total weight of the polyisocyanurate foam-forming composition.

Clause 12: The polyisocyanurate foam-forming composition of any of Clauses 1-11, wherein the trimerization catalyst composition is present in an amount of 1.5% to 3.0% by weight, based on the total weight of the polyisocyanurate foam-forming composition.

Clause 13: The polyisocyanurate foam-forming composition of any of Clauses 1-12, wherein the surfactant comprises a non-reactive silicone surface-active agent having: (i) a Relative Hydrocarbon Solubility of at least 1.20; or (ii) a Surfactant Water Solubility of less than 2%, a Surfactant Turbidity greater than 100, and a Relative Hydrocarbon Solubility of at least 1.05 and less than 1.20; or (iii) a Surfactant Turbidity less than 100, and a Relative Hydrocarbon Solubility of at least 1.05 and less than 1.20.

Clause 14: The polyisocyanurate foam-forming composition of any of Clauses 1-13, wherein the surfactant comprises a non-reactive silicone surface-active agent having a Relative Hydrocarbon Solubility of at least 1.20.

Clause 15: The polyisocyanurate foam-forming composition of any of Clauses 1-14, wherein the surfactant comprises a non-reactive silicone surface-active agent having a Relative Hydrocarbon Solubility of less than 1.20, a Surfactant Water Solubility of 1.0% to 2.0%, and a Surfactant Turbidity of at least 150.

Clause 16: The polyisocyanurate foam-forming composition of any of Clauses 1-15, wherein the blowing agent composition is present in an amount sufficient to produce a polyisocyanurate foam that exhibits an R-value measured according to ASTM C518-17 at a mean temperature of 40° F. that is at least as high as the R-value exhibited by the polyisocyanurate foam when measured at a mean temperature of 75° F.

Clause 17: A polyisocyanurate foam-forming composition comprising: (a) an organic polyisocyanate; and (b) an isocyanate-reactive composition comprising: (1) a polyether polyol or polyester polyol with a nominal hydroxyl functionality of at least 2.0; (2) a blowing agent composition present in an amount sufficient to produce a polyisocyanurate foam that has a density of less than 1.8 lb/ft³ (28.8 kg/m³) and comprising: (i) more than or equal to 6% by weight, based on the total weight of the polyisocyanurate foam-forming composition, of hydrocarbon, wherein: (A) the hydrocarbon comprises cyclopentane and isopentane, wherein the cyclopentane and isopentane are present in a weight ratio of 30:70 to 80:20 such as 70:30, or (B) the hydrocarbon comprises isopentane and n-pentane, wherein the isopentane and n-pentane are present in a weight ratio of 70:30 to 20:80, or (C) the hydrocarbon consists of n-pentane; and (ii) water in an amount no more than 0.2% by weight, based on the total weight of the polyisocyanurate foam-forming composition, wherein hydrocarbon and water are present in the blowing agent composition in a weight ratio of at least 50:1; (3) 1.5 to 3.0% by weight, based on the total weight of the polyisocyanurate foam-forming composition, of a trimerization catalyst composition comprising: (i) an alkali metal carboxylate or an alkaline metal carboxylate, and (ii) a solvent that is not isocyanate-reactive, and (4) a surfactant.

Clause 18: A polyisocyanurate foam comprising a reaction product of a reaction mixture comprising an organic polyisocyanate and an isocyanate-reactive composition, wherein the isocyanate-reactive composition comprises: (1) a polyether polyol or polyester polyol with a nominal hydroxyl functionality of at least 2.0; (2) a blowing agent composition comprising: (i) more than or equal to 6% by weight, based on the total weight of the reaction mixture, of a hydrocarbon; and (ii) water in an amount no more than 0.2% by weight, based on the total weight of the reaction mixture; (3) a trimerization catalyst composition comprising: (i) an alkali metal carboxylate or an alkaline metal carboxylate, and (ii) a solvent that is not isocyanate-reactive, and (4) a surfactant, wherein the polyisocyanurate foam has a density of less than 1.8 lb/ft³ (28.8 kg/m³).

Clause 19: The polyisocyanurate foam of Clause 18, wherein the polyisocyanurate foam exhibits an R-value measured according to ASTM C518-17 at a mean temperature of 40° F. that is at least as high as the R-value exhibited by the polyisocyanurate foam when measured at a mean temperature of 75° F.

Clause 20: An insulated roof assembly comprising: (a) a deck; and (b) insulation panels attached to the deck, the insulation panels comprising the polyisocyanurate foam of any of Clauses 1-19.

Clause 21: A method of making a polyisocyanurate foam comprising reacting an organic polyisocyanate and an isocyanate-reactive composition, wherein the isocyanate-reactive composition comprises: (1) a polyether polyol or polyester polyol with a nominal hydroxyl functionality of at least 2.0; (2) a blowing agent composition comprising: (i) more than 6% by weight, based on the total weight of the total combined weight of the organic polyisocyanate and the isocyanate-reactive composition, of a hydrocarbon; and (ii) water in an amount no more than 0.2% by weight, based on the total combined weight of the organic polyisocyanate and the isocyanate-reactive composition; (3) a trimerization catalyst composition comprising: (i) an alkali metal carboxylate or an alkaline metal carboxylate, and (ii) a solvent that is not isocyanate-reactive, and (4) a surfactant, wherein the polyisocyanurate foam has a density of less than 1.8 lb/ft³ (28.8 kg/m³).

The non-limiting and non-exhaustive examples that follow are intended to further describe various non-limiting and non-exhaustive embodiments without restricting the scope of the embodiments described in this specification.

### EXAMPLES

### Example 1: Characterization of Surfactant Polarity and Blowing Agent Solubilization

Surfactant mixtures were prepared and analyzed in the manner described below according to procedures first detailed in U.S. Pat. No. 10,968,327, which is incorporated herein by reference. Results are shown in Table 1.

### Determination of Surfactant Water Solubility and Turbidity

Surfactant Water Solubility was determined by adding surfactant drop-wise to a 40 mL clear glass vial that contained 15 grams of deionized water. The vial was weighed on an analytical balance, capped, and shaken vigorously between each drop to ensure that the mixture remained clear and the amount of surfactant added was recorded. This process was continued until persistent cloudiness was observed indicating the onset of visual turbidity or the amount of surfactant in the mixture equaled or exceeded 5%. The sample was then subjected to a turbidity analysis using a HACH 2100P Turbidimeter, in which a beam of light is directed through the sample and light scattered by suspended particles in the sample is detected. The intensity of the scattered light is compared to a standard suspension and the result is expressed in Nephelometric Turbidity Units (NTU).

### Determination of Relative Hydrocarbon Solubility in Polyol

A control sample was prepared by blending a selected amount of hydrocarbon blowing agent(s) to be used in a proposed polyisocyanurate foam-forming composition with the polyol(s) to be used in the foam-forming composition using a high-speed air-driven mixer. For these examples, 266.31 grams of Stepanpol® PS-2352 aromatic polyester polyol, commercially available from the Stepan Company, was combined with 58.69 grams of n-pentane to make a control blend. Some of this mixture was immediately transferred to fill a 40 mL clear glass vial, sealed, and the remainder was added to a small-mouth ½ pint jar and capped. This process was repeated except that 3.95 grams of each surfactant was blended separately with 263.07 grams of the polyol prior to adding 57.98 grams of n-pentane. The vials were set aside to allow complete separation of any pentanes that were not dissolved or dispersed in the polyol without the presence of a cloudy interfacial layer. N-pentane blends developed a colorless top layer of the blowing agent within about two weeks, but the cyclopentane control and some of the cyclopentane surfactant blends started out as a cloudy single phase that developed a clear bottom layer that was determined to be comprised primarily of lower molecular weight oligomers of polyester polyol with cyclopentane dissolved in the remainder of the clear polyester polyol upper layer. Some surfactant blends formed clear single-phase solutions. The formation of two clear layers from the cloudy blends took three to ten weeks depending upon lot/batch of polyol used, but no instances of separation of a pure cyclopentane top layer was ever observed with this polyol.

A pipet was used to carefully remove the top liquid layer of aliphatic pentane blowing agent. The test sample was acquired by inserting a pipet halfway down the bottom layer and then evacuating the trapped air inside the pipet tip. Once the pipet was full, it was removed from the sample and the outside was wiped clean before dispensing 1 gram of the polyol into an empty glass vial to record sample weight. Monochlorobenzene (MCB) was added to the sample to obtain a concentration of 1.0 gram in 10 mL. The amount of n-pentane in the polyol sample was determined by direct insertion GC analysis of the MCB solution and applying a multipoint calibration curve to the data. A relative pentane solubility factor was calculated by dividing the pentane concentration normalized to the polyol in the polyol surfactant blend by the pentane concentration in the control polyol prepared on the same date. This value is shown in Table 1 and illustrates the surfactant's ability to dissolve or disperse pentane in the polyol used in the foam formulations.

TABLE 1

| | Surfactant Water Solubility | | Relative Pentane |
|---|---|---|---|
| Surfactant Name | Amount | Turbidity | Solubility |
| Tegostab ® B8871 | 1.31% | 339 | 1.26 |
| Tegostab ® B84504 | 5.30% | 42 | 1.21 |
| NIAX ® L-5140 | 0.47% | 128 | 1.22 |
| NIAX ® L-5112 | 0.33% | 109 | 1.19 |

### Examples 1-7: Preparation of Inventive Polyisocyanurate Foam-Forming Compositions Comprised of Nonreactive Trimerization Catalyst

Various polyisocyanurate foam-forming compositions were prepared using the components and amounts (in parts by weight) listed in Table 2. In each case, the NCO and POLYOL were used in relative amount to provide an isocyanate index (ratio of the equivalent amount of isocyanate used relative to the theoretical equivalent of one equivalent isocyanate per one equivalent of hydroxyl) of 2.84 to 2.89.

TABLE 2

| Component | Ex. 1 | Ex. 2 | Ex. 3 | Ex. 4 | Ex. 5 | Ex. 6 | Ex. 7 |
|---|---|---|---|---|---|---|---|
| POLYOL¹ | 31.06 | 31.06 | 31.06 | 30.90 | 31.05 | 30.42 | 30.23 |
| Fyrol ® PCF² | 3.11 | 3.11 | 3.11 | 3.09 | 3.11 | 3.80 | 3.78 |
| NIAX ® L-5112³ | 0.78 | — | — | — | — | — | — |
| NIAX ® L-5140³ | — | 0.78 | 0.78 | — | — | — | — |
| TEGOSTAB ® B | — | — | — | 0.77 | — | — | — |
| 8871⁴ | | | | | | | |
| TEGOSTAB ® B | — | — | — | — | — | — | 0.76 |
| 84504⁴ | | | | | | | |
| NIAX ™ K-Zero G⁵ | 2.10 | 2.10 | 2.10 | 2.09 | 2.10 | 2.10 | 2.09 |
| Polycat ® 36⁶ | 0.084 | 0.084 | 0.084 | 0.083 | 0.084 | 0.088 | 0.088 |
| Water | 0.099 | 0.099 | 0.099 | 0.099 | 0.099 | 0.097 | 0.097 |
| n-Pentane | 6.95 | 6.95 | 3.48 | 3.46 | 3.47 | — | — |
| Cyclopentane | — | — | — | — | — | 5.00 | 4.97 |
| Isopentane | — | — | 3.48 | 3.46 | 3.47 | 2.14 | 2.13 |
| NCO⁷ | 55.82 | 55.82 | 55.82 | 56.05 | 56.15 | 55.89 | 55.86 |
| Index | 2.84 | 2.84 | 2.84 | 2.84 | 2.84 | 2.88 | 2.89 |

¹Stepanpol ® PS-2352 polyester polyol having a functionality of 2 and an OH Value of 235, which is commercially available from the Stepan Company.
²An alkyl phosphate flame retardant based on Tris(2-chloroisopropyl) phosphate, which is commercially available from ICL-Supresta.
³Surfactant, which is commercially available from Momentive Performance Materials.
⁴Surfactant, which is commercially available from Evonik Industries.
⁵Potassium trimerization catalyst, which is commercially available from Momentive Performance Materials.
⁶Tertiary amine catalyst, which is commercially available from Evonik Industries.
⁷Polymeric MDI, which is commercially available under the name Mondur ® 489 from Covestro LLC.

### Preparation of Polyisocyanurate Faced Foam Laminates

Polyisocyanurate laminated boardstock foam samples were prepared on a pilot-scale Hennecke unit at Covestro LLC (Pittsburgh, Pennsylvania), in which the laminator is approximately 26 feet (7.92 meters) long and equipped with a single mix-head, which makes boards that are 30 inches (0.76 meters) wide. The mix-head is outfitted with a two-stream “T” made with chlorinated polyvinyl chloride piping. The B side resin blend (i.e., isocyanate-reactive component) is premixed with the third-streamed blowing agent inline at 1800 psi (12.41 MPa) to 2500 psi (17.24 MPa) via a special Triple Action Dispersion Device (TADD) from Komax, Inc. prior to entering the static mixer and exiting the mix-head after being subjected to impingement mixing at 1800 psi (12.41 MPa) to 2500 psi (17.24 MPa). The conditions used for foams made in this study were as follows: Total Feed Rate-25 to 35 lbs/min (11.3 to 15.9 kg/min); Resin Temperature −82° F. (27.8° C.); Isocyanate Temperature −82° F. (27.8° C.); Platen Temperature −145° F. (62.8° C.); and Line Speed-25 to 38 ft/min (7.62 to 11.58 m/min).

The nominal board thicknesses for tested foam-forming composition of Table 3 was set at 2 inches (51 mm), and the foam was laminated with fiberglass reinforced cellulosic facer. The board was perforated on the top surface using a weighted spiked roller and on the bottom surface using a fixed spike roller as it exited the unit. The finished faced foam laminate was cut into 8′ (2.44 m) long boards as it exited the laminator, and the boards were stacked in bundles to cure as the chemical reaction went to completion.

The foams met standard foam physical properties requirements for Type II products in accordance with ASTM C 1289, Standard Specification for Faced Rigid Cellular Polyisocyanurate Thermal Insulation Board. Selected physical properties are listed in Table 4.

TABLE 3

| Property | Result |
|---|---|
| Core Density | 1.43 to 1.53 lb/ft³ (22.91 to 24.51 kg/m³) |
| Thickness | 2.14 to 2.19 inches (54.38 to 55.68 millimeters) |

### Measurement of Temperature Dependent Thermal Resistance and Determination of Relative R-Value Index (RRI)

One of the faced foam laminate boards prepared from each of the seven foam formulations was taken from the center of the foam bundle within 24 hours of production after cooling and one 12″×12″ (0.305 m×0.305 m) sample was cut from the center of the board, k-factor was measured at a mean temperature of 75° F. (23.9° C.), and the sample was then stored in a constant temperature/humidity environment. After approximately 30 days, the sample was subjected to a series of 9 programmed k-factor measurements at mean temperatures ranging from 75° F. (23.9 C°) to 25° F. (−3.9° C.) in a single test sequence. The R-values were recorded and the RRI values at each temperature were calculated by taking the R-value of the faced rigid foam laminate at that temperature minus its R-value at 75° F. (23.9° C.) divided by its R-value at 75° F. (23.9° C.) expressed in percent. This information was used to determine the crossover temperature for the foam formulation where the term refers to the temperature where the R-value of a faced rigid foam laminate is equal to its R-value at 75° F. (23.9° C.). Alternatively stated, the crossover temperature is the temperature where the RRI is equal to zero. R-values and RRI values for the faced foam laminates of Examples 1-7 are shown respectively in Table 4 and Table 5.

TABLE 4

| Mean Temperature | Ex. 1 | Ex. 2 | Ex. 3 | Ex. 4 | Ex. 5 | Ex. 6 | Ex. 7 |
|---|---|---|---|---|---|---|---|
| 75° F. (23.9° C.) | 6.13 | 6.33 | 5.85 | 5.95 | 5.92 | 6.71 | 6.67 |
| 70° F. (21.1° C.) | 6.25 | 6.45 | 5.99 | 6.06 | 6.06 | 6.80 | 6.76 |
| 65° F. (18.3° C.) | 6.33 | 6.49 | 6.06 | 6.17 | 6.17 | 6.85 | 6.85 |
| 60° F. (15.6° C.) | 6.37 | 6.49 | 6.13 | 6.25 | 6.29 | 6.85 | 6.90 |
| 55° F. (12.8° C.) | 6.33 | 6.49 | 6.17 | 6.29 | 6.37 | 6.85 | 6.90 |
| 50° F. (10.0° C.) | 6.25 | 6.41 | 6.13 | 6.29 | 6.33 | 6.80 | 6.90 |
| 40° F. (4.4° C.) | 5.92 | 6.17 | 5.95 | 6.13 | 6.02 | 6.76 | 6.80 |
| 35° F. (1.7° C.) | 5.75 | 5.99 | 5.78 | 5.99 | 5.81 | 6.71 | 6.76 |
| 25° F. (−3.9° C.) | 5.43 | 5.68 | 5.49 | 5.62 | 5.32 | 6.67 | 6.67 |

TABLE 5

| Mean Temperature | Ex. 1 | Ex. 2 | Ex. 3 | Ex. 4 | Ex. 5 | Ex. 6 | Ex. 7 |
|---|---|---|---|---|---|---|---|
| 75° F. (23.9° C.) | 0.00% | 0.00% | 0.00% | 0.00% | 0.00% | 0.00% | 0.00% |
| 70° F. (21.1° C.) | 1.88% | 1.94% | 2.40% | 1.82% | 2.42% | 1.36% | 1.35% |
| 65° F. (18.3° C.) | 3.16% | 2.60% | 3.64% | 3.70% | 4.32% | 2.05% | 2.74% |
| 60° F. (15.6° C.) | 3.82% | 2.60% | 4.91% | 5.00% | 6.29% | 2.05% | 3.45% |
| 55° F. (12.8° C.) | 3.16% | 2.60% | 5.56% | 5.66% | 7.64% | 2.05% | 3.45% |
| 50° F. (10.0° C.) | 1.88% | 1.28% | 4.91% | 5.66% | 6.96% | 1.36% | 3.45% |
| 40° F. (4.4° C.) | −3.55% | −2.47% | 1.79% | 3.07% | 1.81% | 0.68% | 2.04% |
| 35° F. (1.7° C.) | −6.32% | −5.39% | −1.16% | 0.60% | −1.74% | 0.00% | 1.35% |
| 25° F. (−3.9° C.) | −11.41% | −10.23% | −6.04% | −5.62% | −10.11% | −0.67% | 0.00% |

### Examples 8-14: Preparation of Comparative Polyisocyanurate Foam-Forming Compositions

Various polyisocyanurate foam-forming compositions were prepared using the components and amounts (in parts by weight) listed in Table 6. In each case, the NCO and POLYOL were used in relative amount to provide an isocyanate index (ratio of the equivalent amount of isocyanate used relative to the theoretical equivalent of one equivalent isocyanate per one equivalent of hydroxyl) of 2.46 to 2.50.

TABLE 6

| Component | Ex. 8 | Ex. 9 | Ex. 10 | Ex. 11 | Ex. 12 | Ex. 13 | Ex. 14 |
|---|---|---|---|---|---|---|---|
| POLYOL¹ | 31.04 | 31.04 | 31.04 | 30.21 | 31.05 | 30.38 | 30.26 |
| Fyrol ® PCF² | 3.10 | 3.11 | 3.10 | 3.78 | 3.11 | 3.80 | 3.78 |
| NIAX ® L-5112³ | 0.78 | — | — | — | — | — | — |
| NIAX ® L-5140³ | — | 0.78 | 0.78 | — | — | — | — |
| TEGOSTAB ® B | — | — | — | 0.76 | — | — | — |
| 8871⁴ | | | | | | | |
| TEGOSTAB ® B | — | — | — | — | — | — | 0.76 |
| 84504⁴ | | | | | | | |
| Dabco ® K-15⁵ | 1.86 | 1.86 | 1.86 | 1.86 | 1.86 | 1.87 | 1.86 |
| Polycat ® 46⁶ | 0.23 | 0.23 | 0.23 | 0.23 | 0.23 | 0.23 | 0.23 |
| Polycat ® 36⁷ | 0.084 | 0.084 | 0.084 | 0.085 | 0.084 | 0.085 | 0.085 |
| Water | 0.099 | 0.099 | 0.099 | 0.097 | 0.099 | 0.097 | 0.097 |
| n-Pentane | 6.95 | 6.95 | 3.47 | 3.55 | 3.47 | — | — |
| Cyclopentane | — | — | — | — | — | 4.89 | 4.87 |
| Isopentane | — | — | 3.47 | 3.55 | 3.47 | 2.10 | 2.09 |
| NCO⁸ | 55.85 | 55.85 | 55.85 | 55.89 | 56.15 | 56.09 | 55.97 |
| Index | 2.46 | 2.46 | 2.46 | 2.50 | 2.46 | 2.50 | 2.50 |

¹Stepanpol ® PS-2352 polyester polyol having a functionality of 2 and an OH Value of 235, which is commercially available from the Stepan Company.
²an alkyl phosphate flame retardant based on Tris(2-chloroisopropyl) phosphate, which is commercially available from ICL-Supresta.
³Surfactant, which is commercially available from Momentive Performance Materials.
⁴Surfactant, which is commercially available from Evonik Industries.
⁵Potassium Octoate trimerization catalyst in DEG, which is commercially available from Evonik Industries under the current brand name Kosmos ® 75.
⁶Potassium Acetate trimerization catalyst, which is commercially available from Evonik Industries under the current brand name Kosmos ® 33.
⁷Tertiary amine catalyst, which is commercially available from Evonik Industries.
⁸Polymeric MDI, which is commercially available under the name Mondur ® 489 from Covestro LLC.

### Preparation of Comparative Polyisocyanurate Faced Foam Laminates

Polyisocyanurate laminated boardstock foam samples were prepared on a pilot-scale Hennecke unit at Covestro LLC (Pittsburgh, Pennsylvania), in which the laminator is approximately 26′ (7.92 meters) long and equipped with a single mix-head, which makes boards that are 30″ (0.76 meters) wide. The mix-head is outfitted with a two-stream “T” made with chlorinated polyvinyl chloride piping. The B side resin blend (i.e., isocyanate-reactive component) is premixed with the third-streamed blowing agent inline at 1800 psi (12.41 MPa) to 2500 psi (17.24 MPa) via a special TADD from Komax, Inc. prior to entering the static mixer and exiting the mix-head after being subjected to impingement mixing at 1800 psi (12.41 MPa) to 2500 psi (17.24 MPa). The conditions used for foams made in this study were as follows: Total Feed Rate-25 to 35 lbs/min (11.3 to 15.9 kg/min); Resin Temperature −82° F. (27.8° C.); Isocyanate Temperature −82° F. (27.8° C.); Platen Temperature −145° F. (62.8° C.); and Line Speed-25 to 38 ft/min (7.62 to 11.58 m/min).

The nominal board thicknesses for tested foam-forming composition of Table 7 was set at 2″ (51 mm) and the foam was laminated with fiberglass reinforced cellulosic facer. The board was perforated on the top surface using a weighted spiked roller and on the bottom surface using a fixed spike roller as it exited the unit. The finished faced foam laminate was cut into 8′ (2.44 m) long boards as it exited the laminator, and the boards were stacked in bundles to cure as the chemical reaction went to completion.

The foams met standard foam physical properties requirements for Type II products in accordance with ASTM C 1289, Standard Specification for Faced Rigid Cellular Polyisocyanurate Thermal Insulation Board. Selected physical properties are listed in Table 7.

TABLE 7

| Property | Result |
|---|---|
| Core Density | 1.41 to 1.49 lb/ft³ (22.59 to 23.87 kg/m³) |
| Thickness | 2.07 to 2.19 inches (52.58 to 55.63 millimeters) |

### Measurement of Temperature Dependent Thermal Resistance and Determination of Relative R-Value Index (RRI)

One of the faced foam laminate boards prepared from each of the seven comparative foam formulations was taken from the center of the foam bundle within 24 hours of production after cooling and one 12″×12″ (0.305 m×0.305 m) sample was cut from the center of the board, k-factor was measured at a mean temperature of 75° F. (23.9° C.), and the sample was then stored in a constant temperature/humidity environment. After approximately 20 to 30 days, the sample is subjected to a series of 9 programmed k-factor measurements at mean temperatures ranging from 75° F. (23.9 C°) to 25° F. (−3.9° C.) in a single test sequence. The R-values are recorded and the RRI values at each temperature are calculated by taking the R-value of the faced rigid foam laminate at that temperature minus its R-value at 75° F. (23.9° C.) divided by its R-value at 75° F. (23.9° C.) expressed in percent. This information was used to determine the crossover temperature for the foam formulation, i.e., the temperature where the R-value of a faced rigid foam laminate is equal to its R-value at 75° F. (23.9° C.). Alternatively stated, the crossover temperature is the temperature where the RRI is equal to zero. R-values and RRI values for the faced foam laminates according to the present disclosure are shown respectively in Table 8 and Table 9.

TABLE 8

| Mean Temperature | Ex. 8 | Ex. 9 | Ex. 10 | Ex. 11 | Ex. 12 | Ex. 13 | Ex. 14 |
|---|---|---|---|---|---|---|---|
| 75° F. (23.9° C.) | 6.13 | 6.29 | 5.81 | 6.17 | 5.88 | 6.67 | 6.58 |
| 70° F. (21.1° C.) | 6.25 | 6.37 | 5.95 | 6.29 | 6.02 | 6.67 | 6.62 |
| 65° F. (18.3° C.) | 6.33 | 6.37 | 6.06 | 6.37 | 6.17 | 6.62 | 6.67 |
| 60° F. (15.6° C.) | 6.33 | 6.33 | 6.13 | 6.45 | 6.25 | 6.49 | 6.67 |
| 55° F. (12.8° C.) | 6.29 | 6.25 | 6.17 | 6.41 | 6.21 | 6.33 | 6.62 |
| 50° F. (10.0° C.) | 6.17 | 6.10 | 6.13 | 6.37 | 6.06 | 6.21 | 6.58 |
| 40° F. (4.4° C.) | 5.85 | 5.65 | 5.92 | 6.06 | 5.46 | 5.92 | 6.41 |
| 35° F. (1.7° C.) | 5.65 | 5.43 | 5.71 | 5.85 | 5.15 | 5.78 | 6.33 |
| 25° F. (−3.9° C.) | 5.32 | 5.08 | 5.32 | 5.43 | 4.63 | 5.59 | 6.17 |

TABLE 9

| Mean Temperature | Ex. 8 | Ex. 9 | Ex. 10 | Ex. 11 | Ex. 12 | Ex. 13 | Ex. 14 |
|---|---|---|---|---|---|---|---|
| 75° F. (23.9° C.) | 0.00% | 0.00% | 0.00% | 0.00% | 0.00% | 0.00% | 0.00% |
| 70° F. (21.1° C.) | 1.88% | 1.27% | 2.38% | 1.89% | 2.41% | 0.00% | 0.66% |
| 65° F. (18.3° C.) | 3.16% | 1.27% | 4.24% | 3.18% | 4.94% | −0.66% | 1.33% |
| 60° F. (15.6° C.) | 3.16% | 0.63% | 5.52% | 4.52% | 6.25% | −2.60% | 1.33% |
| 55° F. (12.8° C.) | 2.52% | −0.62% | 6.17% | 3.85% | 5.59% | −5.06% | 0.66% |
| 50° F. (10.0° C.) | 0.62% | −3.05% | 5.52% | 3.18% | 3.03% | −6.83% | 0.00% |
| 40° F. (4.4° C.) | −4.68% | −10.17% | 1.78% | −1.82% | −7.10% | −11.24% | −2.56% |
| 35° F. (1.7° C.) | −7.91% | −13.59% | −1.71% | −5.26% | −12.37% | −13.29% | −3.80% |
| 25° F. (−3.9° C.) | −13.30% | −19.29% | −8.51% | −11.96% | −21.30% | −16.20% | −6.17% |

Any patent, publication, or other disclosure material identified herein is incorporated by reference into this specification in its entirety unless otherwise indicated, but only to the extent that the incorporated material does not conflict with existing definitions, statements, or other disclosure material expressly set forth in this specification. As such, and to the extent necessary, the express disclosure as set forth in this specification supersedes any conflicting material incorporated by reference herein. Any material, or portion thereof, that is said to be incorporated by reference into this specification, but which conflicts with existing definitions, statements, or other disclosure material set forth herein, is only incorporated to the extent that no conflict arises between that incorporated material and the existing disclosure material. Applicant(s) reserves the right to amend this specification to expressly recite any subject matter, or portion thereof, incorporated by reference herein.

In this specification, other than where otherwise indicated, all numerical parameters are to be understood as being prefaced and modified in all instances by the term “about,” in which the numerical parameters possess the inherent variability characteristic of the underlying measurement techniques used to determine the numerical value of the parameter. At the very least, and not as an attempt to limit the application of the doctrine of equivalents to the scope of the claims, each numerical parameter described in the present description should at least be construed in light of the number of reported significant digits and by applying ordinary rounding techniques.

Also, any numerical range recited in this specification is intended to include all sub-ranges of the same numerical precision subsumed within the recited range. For example, a range of “1.0 to 10.0” is intended to include all sub-ranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited in this specification is intended to include all lower numerical limitations subsumed therein, and any minimum numerical limitation recited in this specification is intended to include all higher numerical limitations subsumed therein. Accordingly, Applicant(s) reserves the right to amend this specification, including the claims, to expressly recite any sub-range subsumed within the ranges expressly recited herein. All such ranges are intended to be inherently described in this specification.

The grammatical articles “one,” “a,” “an,” and “the,” as used in this specification, are intended to include “at least one” or “one or more,” unless otherwise indicated. Thus, the articles are used in this specification to refer to one or more than one (i.e., to “at least one”) of the grammatical objects of the article. By way of example, “a component” means one or more components, and thus, possibly, more than one component is contemplated and may be employed or used in an implementation of the described embodiments. Further, the use of a singular noun includes the plural, and the use of a plural noun includes the singular, unless the context of the usage requires otherwise.

This specification has been written with reference to various non-limiting and non-exhaustive embodiments. However, it will be recognized by persons having ordinary skill in the art that various substitutions, modifications, or combinations of any of the disclosed embodiments (or portions thereof) may be made within the scope of this specification. Thus, it is contemplated and understood that this specification supports additional embodiments not expressly set forth herein. Such embodiments may be obtained, for example, by combining, modifying, or reorganizing any of the disclosed steps, components, elements, features, aspects, characteristics, limitations, and the like, of the various non-limiting embodiments described in this specification. In this manner, Applicant(s) reserves the right to amend the claims during prosecution to add features as variously described in this specification, and such amendments comply with the requirements of 35 U.S.C. § 112, first paragraph, and 35 U.S.C. § 132 (a).

What is claimed is:

1. A polyisocyanurate foam-forming composition comprising:
(a) an organic polyisocyanate; and
(b) an isocyanate-reactive composition comprising:
(1) a polyether polyol or polyester polyol with a nominal hydroxyl functionality of at least 2.0;
(2) a blowing agent composition present in an amount sufficient to produce a polyisocyanurate foam that has a density of less than 1.8 lb/ft³ (28.8 kg/m³) and comprising:
(i) more than or equal to 6% by weight, based on the total weight of the polyisocyanurate foam-forming composition, of a hydrocarbon; and
(ii) water in an amount no more than 0.2% by weight, based on the total weight of the polyisocyanurate foam-forming composition;
(3) a trimerization catalyst composition comprising:
(i) an alkali metal carboxylate or an alkaline metal carboxylate, and
(ii) a solvent that is not isocyanate-reactive; and
(4) a surfactant.

2. The polyisocyanurate foam-forming composition of claim 1, wherein the trimerization catalyst composition comprises water in an amount of less than 25% by weight, based on the total weight of the trimerization catalyst composition.

3. The polyisocyanurate foam-forming composition of claim 1, wherein the trimerization catalyst composition comprises water in an amount of less than 5% by weight, based on the total weight of the trimerization catalyst composition.

4. The polyisocyanurate foam-forming composition of claim 1, wherein the alkali metal carboxylate or alkaline metal carboxylate comprises potassium.

5. The polyisocyanurate foam-forming composition of claim 4, wherein the alkali metal carboxylate or alkaline metal carboxylate comprises an octoate.

6. The polyisocyanurate foam-forming composition of claim 1, wherein the solvent comprises an aprotic solvent.

7. The polyisocyanurate foam-forming composition of claim 6, wherein the aprotic solvent comprises a methoxyether, polyethylene glycol di-2-ethylhexanoate, an acetate, an adipate, a phthalate, a ketone, a phosphate ester, a tertiary amine, a dialkyl sulfoxide, a N,N-dialkylalkanoamide, an aryl or alkyl phosphonate, a trialkyl phosphate, an organic carbonate, or a mixture of two or more thereof.

8. The polyisocyanurate foam-forming composition of claim 1, wherein the hydrocarbon comprises n-pentane, isopentane, cyclopentane, or a mixture of two or more thereof.

9. The polyisocyanurate foam-forming composition of claim 1, wherein the hydrocarbon consists of n-pentane.

10. The polyisocyanurate foam-forming composition of claim 1, wherein the blowing agent composition comprises more than or equal to 6.4% by weight, based on the total weight of the polyisocyanurate foam-forming composition, of a hydrocarbon.

11. The polyisocyanurate foam-forming composition of claim 8, wherein the hydrocarbon comprises cyclopentane and isopentane, wherein the cyclopentane and isopentane are present in a weight ratio of 30:70 to 80:20.

12. The polyisocyanurate foam-forming composition of claim 11, wherein the hydrocarbon comprises cyclopentane and isopentane, wherein the cyclopentane and isopentane are present in a weight ratio of 70:30.

13. The polyisocyanurate foam-forming composition of claim 8, wherein the hydrocarbon comprises isopentane and n-pentane, wherein the isopentane and n-pentane are present in a weight ratio of 70:30 to 20:80.

14. The polyisocyanurate foam-forming composition of claim 1, wherein hydrocarbon and water are present in the blowing agent composition in a weight ratio of at least 50:1.

15. The polyisocyanurate foam-forming composition of claim 14, wherein hydrocarbon and water are present in the blowing agent composition in a weight ratio of at least 70:1.

16. The polyisocyanurate foam-forming composition of claim 1, wherein the water is present in the blowing agent composition in an amount no more than 0.15% by weight, based on the total weight of the polyisocyanurate foam-forming composition.

17. The polyisocyanurate foam-forming composition of claim 16, wherein the water is present in the blowing agent composition in an amount of no more than 0.10% by weight, based on the total weight of the polyisocyanurate foam-forming composition.

18. The polyisocyanurate foam-forming composition of claim 1, wherein the trimerization catalyst composition is present in an amount of 1.5% to 3.0% by weight, based on the total weight of the polyisocyanurate foam-forming composition.

19. The polyisocyanurate foam-forming composition of claim 1, wherein the surfactant comprises a non-reactive silicone surface-active agent having:
(i) a Relative Hydrocarbon Solubility of at least 1.20;
(ii) a Surfactant Water Solubility of less than 2%, a Surfactant Turbidity greater than 100, and a Relative Hydrocarbon Solubility of at least 1.05 and less than 1.20; or
(iii) a Surfactant Turbidity less than 100 and a Relative Hydrocarbon Solubility of at least 1.05 and less than 1.20.

20. The polyisocyanurate foam-forming composition of claim 1, wherein the surfactant comprises a non-reactive silicone surface-active agent having a Relative Hydrocarbon Solubility of at least 1.20.

21. The polyisocyanurate foam-forming composition of claim 1, wherein the surfactant comprises a non-reactive silicone surface-active agent having a Relative Hydrocarbon Solubility of less than 1.20, a Surfactant Water Solubility of 1.0% to 2.0%, and a Surfactant Turbidity of at least 150.

22. The polyisocyanurate foam-forming composition of claim 1, wherein the blowing agent composition is present in an amount sufficient to produce a polyisocyanurate foam that exhibits an R-value measured according to ASTM C518-17 at a mean temperature of 40° F. that is at least as high as the R-value exhibited by the polyisocyanurate foam when measured at a mean temperature of 75° F.

23. A polyisocyanurate foam-forming composition comprising:
(a) an organic polyisocyanate; and
(b) an isocyanate-reactive composition comprising:
(1) a polyether polyol or polyester polyol with a nominal hydroxyl functionality of at least 2.0;
(2) a blowing agent composition present in an amount sufficient to produce a polyisocyanurate foam that has a density of less than 1.8 lb/ft³ (28.8 kg/m³) and comprising:
(i) more than or equal to 6% by weight, based on the total weight of the polyisocyanurate foam-forming composition, of hydrocarbon, wherein:
(A) the hydrocarbon comprises cyclopentane and isopentane, wherein the cyclopentane and isopentane are present in a weight ratio of 30:70 to 80:20, or
(B) the hydrocarbon comprises isopentane and n-pentane, wherein the isopentane and n-pentane are present in a weight ratio of 70:30 to 20:80, or
(C) the hydrocarbon consists of n-pentane; and
(ii) water in an amount no more than 0.2% by weight, based on the total weight of the polyisocyanurate foam-forming composition,
wherein hydrocarbon and water are present in the blowing agent composition in a weight ratio of at least 50:1;
(3) 1.5 to 3.0% by weight, based on the total weight of the polyisocyanurate foam-forming composition, of a trimerization catalyst composition comprising:
(i) an alkali metal carboxylate or an alkaline metal carboxylate, and
(ii) a solvent that is not isocyanate-reactive, and
(4) a surfactant.

24. A polyisocyanurate foam comprising a reaction product of a reaction mixture comprising an organic polyisocyanate and an isocyanate-reactive composition, wherein the isocyanate-reactive composition comprises:
(1) a polyether polyol or polyester polyol with a nominal hydroxyl functionality of at least 2.0;
(2) a blowing agent composition comprising:
(i) more than or equal to 6% by weight, based on the total weight of the reaction mixture, of a hydrocarbon; and
(ii) water in an amount no more than 0.2% by weight, based on the total weight of the reaction mixture;
(3) a trimerization catalyst composition comprising:
(i) an alkali metal carboxylate or an alkaline metal carboxylate, and
(ii) a solvent that is not isocyanate-reactive, and
(4) a surfactant,
wherein the polyisocyanurate foam has a density of less than 1.8 lb/ft³ (28.8 kg/m³).

25. The polyisocyanurate foam of claim 24, wherein the polyisocyanurate foam exhibits an R-value measured according to ASTM C518-17 at a mean temperature of 40° F. that is at least as high as the R-value exhibited by the polyisocyanurate foam when measured at a mean temperature of 75° F.

26. An insulated roof assembly comprising:
(a) a deck; and
(b) insulation panels attached to the deck, the insulation panels comprising the polyisocyanurate foam of claim 24.

27. A method of making a polyisocyanurate foam comprising reacting an organic polyisocyanate and an isocyanate-reactive composition, wherein the isocyanate-reactive composition comprises:
(1) a polyether polyol or polyester polyol with a nominal hydroxyl functionality of at least 2.0;
(2) a blowing agent composition comprising:
(i) more than or equal to 6% by weight, based on the total weight of the total combined weight of the organic polyisocyanate and the isocyanate-reactive composition, of a hydrocarbon; and
(ii) water in an amount no more than 0.2% by weight, based on the total combined weight of the organic polyisocyanate and the isocyanate-reactive composition;
(3) a trimerization catalyst composition comprising:
(i) an alkali metal carboxylate or an alkaline metal carboxylate, and (ii) a solvent that is not isocyanate-reactive, and
(4) a surfactant,
wherein the polyisocyanurate foam has a density of less than 1.8 lb/ft³ (28.8 kg/m³).
